(19) United States
(12) Patent Application Publication
(10) Pub. No.: US 2025/0347042 A1
(43) Pub. Date: Nov. 13, 2025

(54) BREATHABLE ELASTIC COMPOSITES

(71) Applicant: MAGNERA CORPORATION, Charlotte, NC (US)

(72) Inventors: Iyad Muslet, West Chester, OH (US); Paul Michael Harmon, Troutman, NC (US); Andrew W. Delaney, Allentown, NJ (US); Christopher Aaron Shelley, Lebanon, OH (US); Dianne B. Ellis, Cary, NC (US); Jerry Snider, Mooresville, NC (US)

(21) Appl. No.: 19/202,239

(22) Filed: May 8, 2025

Related U.S. Application Data
(60) Provisional application No. 63/644,033, filed on May 8, 2024.

(51) Int. Cl. D04H 1/4374; B32B 3/26; B32B 5/02; B32B 5/06; B32B 27/12; D04H 1/435; D04H 1/492; D04H 1/498

(52) U.S. Cl. CPC D04H 1/4374; B32B 3/266; B32B 5/022; B32B 5/067; B32B 27/12; D04H 1/435; D04H 1/492; D04H 1/498; B32B 2250/40; B32B 2307/51; B32B 2307/718; B32B 2307/724; B32B 2307/7376; B32B 2307/748; D10B 2401/061

(57) ABSTRACT

Breathable elastic composites including a first nonwoven material comprising a first plurality of fibers, a second nonwoven material comprising a second plurality of fibers, and a film comprising a plurality of apertures, in which the film is located between the first nonwoven material and the second nonwoven material. At least a portion the first plurality of fibers and/or at least a portion of the second plurality of fibers extend through at least a portion of the plurality of apertures and are physically entangled together.

### CROSS-REFERENCE TO RELATED APPLICATIONS

This application is a U.S. non-provisional application that claims priority to U.S. Provisional Application No. 63/644,033 filed May 8, 2024, which is expressly incorporated by reference herein in its entirety.

### TECHNICAL FIELD

Embodiments of the presently-disclosed invention relate generally to breathable elastic composites comprising a perforated film located between two nonwoven materials, in which fibers of the two nonwoven materials are mechanically entangled together through apertures of the perforated film.

### BACKGROUND

Elasticized materials (e.g., webs, composites, laminates, etc.) have been manufactured in a variety of ways. One popular approach utilizes one or more elastic strands that are elongated by a tensioning force and is attached, such as by an adhesive, to a non-tensioned substrate, which is then gathered when the strands are relaxed. The adhesive may be applied by means of spraying to the elongated elastic strands and to the non-tensioned substrate before the elongated strands are made to contact the substrate to form the elastic web or laminate. After the elongated strand and the non-tensioned substrate have been brought in contact, the tensioning force on the strands is removed, and the strands are relaxed. The elastic strands then contract back towards their original, non-tensioned length, thereby gathering the substrate and thus forming a corrugated web or laminate.

However, there are some drawbacks with the above-described production technology and the product obtained. For example, there is a risk that the adhesive is applied in an irregular manner on the product, whereby an uneven surface structure is obtained for the laminate. Also, the components of the production machinery, as well as undesired areas of the product may become contaminated by the adhesive. The adhesive tends to stiffen the product in those areas where an adhesive is present. These areas become less flexible than those areas having no adhesive. Also, if the adhesive is applied evenly over the surface of the nonwoven material, the adhesive will stiffen the nonwoven material and may make it less flexible. The stiffness and inflexibility also affects the product in such a way that when the product is folded, permanent folding marks arise in the product. In addition, the adhesive tends to reduce the breathability of the product, something which may be disadvantageous in products such as disposable diapers, where air permeability is often desired.

In this regard, there remains a need in the art for elastic composite materials formed from nonwoven materials and an elastic film.

### SUMMARY OF INVENTION

One or more embodiments of the invention may address one or more of the aforementioned problems. Certain embodiments according to the invention provide a composite including the following: (i) a first nonwoven material comprising a first plurality of fibers; (ii) a second nonwoven material comprising a second plurality of fibers; and (iii) a film comprising a plurality of apertures, wherein the film is located between the first nonwoven material and the second nonwoven material; in which at least a portion the first plurality of fibers and/or at least a portion of the second plurality of fibers extend through the plurality of apertures and are physically entangled together.

In another aspect, certain embodiments according to the invention provide a method of forming a composite including the following steps: (i) providing or forming a first nonwoven material comprising a first plurality of fibers; (ii) providing or forming a second nonwoven material comprising a second plurality of fibers; (iii) providing or forming a film comprising a plurality of apertures; (iv) positioning the film between the first nonwoven material and the second nonwoven material; and (v) physically entangling at least a portion the first plurality of fibers and/or at least a portion of the second plurality of fibers together through at least a portion of the plurality of apertures.

### BRIEF DESCRIPTION OF THE DRAWING(S)

The invention now will be described more fully hereinafter with reference to the accompanying drawings, in which some, but not all embodiments of the invention are shown. Indeed, this invention may be embodied in many different forms and should not be construed as limited to the embodiments set forth herein; rather, these embodiments are provided so that this disclosure will satisfy applicable legal requirements. Like numbers refer to like elements throughout, and wherein:

FIG. 1 illustrates a cross-sectional view of a composite in accordance with certain embodiments of the invention;

FIG. 2 illustrates a plurality of freely-open apertures in which a portion have a truncated structure and while other have a planar structure in accordance with certain embodiments of the invention;

FIG. 3A illustrates a film having a plurality of apertures comprising individual slits in a relaxed or closed state in accordance with certain embodiments of the invention;

FIG. 3B illustrates the film of FIG. 3A in an extended state (e.g., under tension) and the individual slits are in on open state in accordance with certain embodiments of the invention;

FIG. 4 illustrates an example breathable elastic composite in accordance with certain embodiments of the invention; and

FIG. 5 illustrates another example breathable elastic composite in accordance with certain embodiments of the invention.

### DETAILED DESCRIPTION

The invention now will be described more fully hereinafter. Indeed, this invention may be embodied in many different forms and should not be construed as limited to the embodiments set forth herein; rather, these embodiments are provided so that this disclosure will satisfy applicable legal requirements. As used in the specification, and in the appended claims, the singular forms “a”, “an”, “the”, include plural referents unless the context clearly dictates otherwise.

The presently-disclosed invention relates generally to breathable elastic composites comprising at least one perforated film (e.g., a perforated elastic film) having a plurality of apertures extending through the entire thickness of the film. The film is located between and in contact with two nonwoven materials (e.g., nonwoven web and/or nonwoven fabric). For example, a first nonwoven material may be located on a first side of the film and a second nonwoven material may be located on an opposite, second side of the film. At least a portion of a first plurality of fibers of the first nonwoven material and/or at least a portion of a second plurality of fibers of the second nonwoven material extend through at least a portion of the plurality of apertures and are physically entangled together. In this regard, the elastic film imparts a desirable degree of elasticity to the composite while the outer nonwoven layers of the composite being physically entangled together through the apertures of the film provide improved resistance to delamination. In accordance with certain embodiments of the invention, the composites may be breathable due to the plurality of apertures and/or the polymeric material forming the film may be vapor breathable.

The term “nonwoven material”, as used herein, may include a nonwoven web and/or a nonwoven fabric.

The terms “nonwoven” and “nonwoven web”, as used herein, may comprise a web having a structure of individual fibers, fibers, and/or threads that are interlaid but not in an identifiable repeating manner as in a knitted or woven fabric. Nonwoven webs, according to certain embodiments of the invention, may be formed by any process conventionally known in the art such as, for example, meltblowing processes, spunbonding processes, air-laid, and carded web processes. A “nonwoven web”, as used herein, may comprise a plurality of individual fibers that have not been subjected to a consolidating process. In certain instances, the “nonwoven web” may comprises a plurality of layers, such as one or more spunbond layers and/or one or more meltblown layers. For instance, a “nonwoven web” may comprises a spunbond-meltblown-spunbond structure.

The terms “fabric” and “nonwoven fabric”, as used herein, may comprise a web of fibers in which a plurality of the fibers are mechanically entangled or interconnected, fused together, and/or chemically bonded together. For example, a nonwoven web of individually laid fibers may be subjected to a bonding or consolidation process to bond at least a portion of the individually fibers together to form a coherent (e.g., united) web of interconnected fibers.

The term “consolidated” and “consolidation”, as used herein, may comprise the bringing together of at least a portion of the fibers of a nonwoven web into closer proximity or attachment there-between (e.g., thermally fused together, chemically bonded together, and/or mechanically entangled together) to form a bonding site, or bonding sites, which function to increase the resistance to external forces (e.g., abrasion and tensile forces), as compared to the unconsolidated web. The bonding site or bonding sites, for example, may comprise a discrete or localized region of the web material that has been softened or melted and optionally subsequently or simultaneously compressed to form a discrete or localized deformation in the web material. Furthermore, the term “consolidated” may comprise an entire nonwoven web that has been processed such that at least a portion of the fibers are brought into closer proximity or attachment there-between (e.g., thermally fused together, chemically bonded together, and/or mechanically entangled together), such as by thermal bonding or mechanical entanglement (e.g., hydroentanglement) as merely a few examples. Furthermore, the term “consolidated” and “consolidation” may comprise the bonding by means of a through-air-bonding operation. The term “through-air bonded” and “though-air-bonding”, as used herein, may comprise a nonwoven web consolidated by a bonding process in which hot air is used to fuse the fibers at the surface of the web and optionally internally within the web. By way of example only, hot air can either be blown through the web in a conveyorized oven or sucked through the web as it passes over a porous drum as a vacuum is developed. The temperature of and the rate of hot air are parameters that may determine the level or the extent of bonding in nonwoven web. In accordance with certain embodiments of the invention, the temperature of the hot air may be high enough to melt, induce flowing, and/or fuse the a plurality of fibers having a lower melting point temperature or onset of lower melting point temperature (e.g., amorphous fibers) to a plurality of fibers having a higher melting point temperature or onset of lower melting point temperature (e.g., semi-crystalline or crystalline fibers). Such a web may be considered a “consolidated nonwoven”, “nonwoven fabric” or simply as a “fabric” according to certain embodiments of the invention.

The term “elastic”, “elastomer” or “elastomeric”, as used interchangeably herein, may comprise a material that when stretched and released will recover to near its original length (e.g., return to within 20%, 10%, 5%, 3%, or 1% of its original length). The term “elastic”, “elastomer”, or “elastomeric”, as used interchangeably herein, may also comprise a material that exhibits the ability to be stretched and released several times and, to exert repetitively the same or just slightly lower force when stretched at the same extension level. Elastic materials, for example, may comprise elastomers, such as elastomeric polymers. Non-limiting exemplary elastomers may comprise, according to certain embodiments, one or more elastomers such as an acrylate; a polyolefin, such as polyethylene, polypropylene, polybutylene, polyhexene, polyoctene; polystyrenes; polyurethanes; polyesters, such as polyethyleneterephthalate; polyamides such as nylon; natural or synthetic rubber resins such as styrenic block copolymers (e.g., styrene-isoprene-styrene, styrene-butadiene-styrene, styrene-ethylene-ethylene-propylene-styrene copolymers, styrene-ethylene-butylene-styrene); epoxies; vinyl acetates, such as ethylene vinyl acetate; polydiorganosiloxane polyurea copolymers; copolymers thereof and mixtures thereof. Additionally or alternatively, non-limiting elastomers may include elastomeric polyolefins (e.g., VISTAMAXX™ from ExxonMobil Chemical Company, VERSIFY™, a propylene-ethylene elastomeric polymer, and AFFINITY™ from The Dow Chemical Company), polyether block amide copolymer (e.g., PEBAX® from Arkema Group), polyester block amide copolymer, copolyester thermoplastic elastomer (e.g., ARNITEL® from DSM Engineering Plastics, HY TREL® from E.I. DuPont de Nemours and Company), thermoplastic urethane elastomer, and/or combinations thereof. In certain embodiments, example elastomers may comprise VISTAMAXX™ propylene-based elastomers (commercially available form ExxonMobile), which comprise copolymers of propylene and ethylene. VISTAMAXX™ propylene-based elastomers, for example, comprise isotactic polypropylene microcrystalline regions and random amorphous regions.

“Elastic stretch,” “elasticity,” or variants thereof, means the degree to which a film or composite may be stretched before breaking or becoming permanently deformed. Elastic stretch is typically expressed as a percentage of the original length. For example, an elastic stretch of 100% means that a film or composite may be stretched to about twice its original length before breaking or permanent deformation.

The term “permanent set”, as used herein, may refer to the permanent deformation of a material after removal of an applied load. In the case of elastomeric films or composites, permanent set is the increase in length of a sample after the film or composite has been stretched to a given length and then allowed to relax as described herein. Permanent set is typically expressed as a percent increase relative to the original size, therefore, a film or composite that recovers to a length of 1.2 times the original length is said to have a permanent set of about 20%.

The term “machine direction” or “MD”, as used herein, comprises the direction in which the fabric produced or conveyed. The term “cross-direction” or “CD”, as used herein, comprises the direction of the fabric substantially perpendicular to the M D.

The term “layer”, as used herein, may comprise a generally recognizable combination of similar material types and/or functions existing in the X-Y plane.

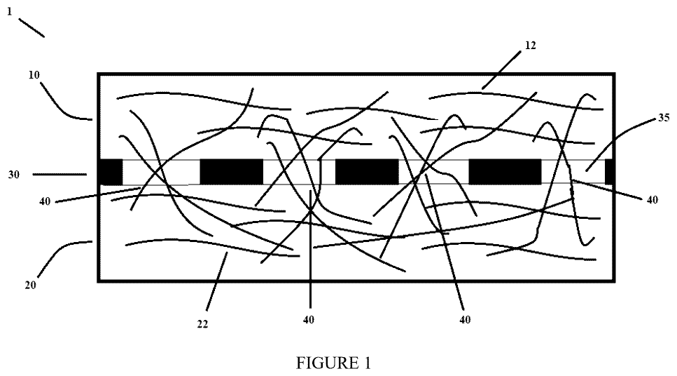

Certain embodiments of the invention may be directed to a composite (e.g., breathable elastic composite) including the following: (i) a first nonwoven material comprising a first plurality of fibers; (ii) a second nonwoven material comprising a second plurality of fibers; and (iii) a film comprising a plurality of apertures, wherein the film is located between the first nonwoven material and the second nonwoven material; in which at least a portion the first plurality of fibers and/or at least a portion of the second plurality of fibers extend through the plurality of apertures and are physically entangled together. FIG. 1, for example, a cross-sectional view of a composite 1 in accordance with certain embodiments of the invention. The composite 1 (e.g., breathable elastic composite) includes a first nonwoven material 10 comprising a first plurality of fibers 12; (ii) a second nonwoven material 20 comprising a second plurality of fibers 22; and (iii) a film 30 comprising a plurality of apertures 35. As shown in FIG. 1, the film 30 is located between the first nonwoven material 10 and the second nonwoven material 20, in which at least a portion the first plurality of fibers 40 and/or at least a portion of the second plurality of fibers 40 extend through the plurality of apertures 35 and are physically entangled together.

In accordance with certain embodiments of the invention, the plurality of apertures may define an open area from about 0.1 to about 90% in a relaxed state (e.g., when the film is under no tension), such as at least about any of the following: 0.1, 1, 3, 5, 8, 10, 12, 14, 15, 16, 18, 20, 25, 30, 35, 40, and 45% in a relaxed state, and/or at most about any of the following: 90, 85, 80, 75, 70, 65, 60, 55, 50, and 45% in a relaxed state. Additionally or alternatively, the film may have an aperture density from about 1 aperture per cm² to about 300 apertures per cm², such as at least about any of the following: 1, 2, 4, 5, 6, 8, 10, 12, 14, 15, 20, 25, 30, 40, 50, 60, 70, 80, 90, 100, 110, 120, 130, 140, and 150 apertures per cm², and/or at most about any of the following: 300, 280, 260, 240, 220, 200, 190, 180, 170, 160, and 150 apertures per cm².

The plurality of apertures, in accordance with certain embodiments of the invention, may comprise a plurality of slits that are in a closed state when the film is in a relaxed state (e.g., when the film is under no tension) and transition to an open state when the film is under tension or in an extended state. The plurality of slits, for example, may each have a short dimension and a long direction, in which the respective long dimensions may be aligned in a cross-direction (CD) of the film. Alternatively, the plurality of slits may each have a short dimension and a long direction, and wherein the respective long dimensions are aligned in a machine-direction (M D) of the film. In accordance with certain embodiments of the invention, the plurality of slits each have a short dimension and a long direction, and wherein a first portion of the respective long dimensions are aligned in a first direction, such as a cross-direction (CD) of the film, and second portion of the respective long dimensions are aligned in a second direction, such as a machine-direction (M D) of the film. In accordance with certain embodiments of the invention, the plurality of slits each have a short dimension and a long direction, and wherein the respective long dimensions are aligned at an angle from about 5 to about 85° from a cross-direction (CD) of the film, such as at least about 5, 10, 15, 20, 25, 30, 35, 40, and 45° from the CD of the film, and/or at most about any of the following: 85, 80, 75, 70, 65, 60, 55, 50, and 45° from the CD of the film. Additionally or alternatively, the plurality of apertures may comprise a plurality of freely open apertures having an average individual area from about 0.02 to about 200 mm² when the film is in a relaxed state, such as at least about any of the following: 0.02, 0.1, 0.12, 0.14, 0.15, 0.16, 0.18, 0.2, 0.25, 0.3, 0.35, 0.4, 0.5, 0.8, 1, 2, 5, 8, 10, 15, 20, 25, 30, 35, 40, 50, 60, 70, and 80 mm² when the film is in a relaxed state and/or at most about any of the following: 200, 180, 160, 150, 140, 120, 100, and 80 mm² when the film is in a relaxed state. In accordance with certain embodiments of the invention, the plurality of apertures may comprise a combination of the plurality of slits and the plurality of freely open apertures.

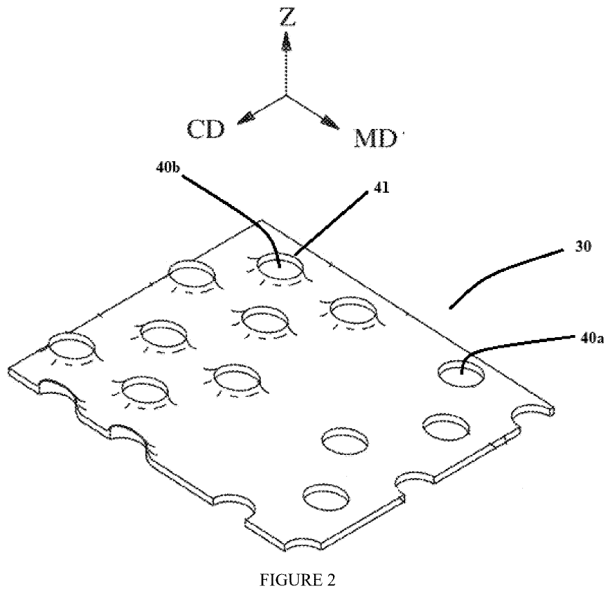

In accordance with certain embodiments of the invention, the plurality of apertures may comprise a truncated structure having an out-of-plane geometry in relation to a plane defined by the film. Additionally or alternatively, the plurality of apertures may comprise a planar structure substantially devoid of an out-of-plane geometry in relation to a plane defined by the film. FIG. 2, for instance, illustrates a film 30 including a plurality of freely-open apertures 40b in which a portion have a truncated structure 41 and while another plurality of freely-open apertures 40a have a planar structure in accordance with certain embodiments of the invention. The truncated structure may be formed from a stretched and/or plastically deformed portion in the z-direction that creates an out-of-plane geometry having, for example, a conical shaped truncated structure and apertures.

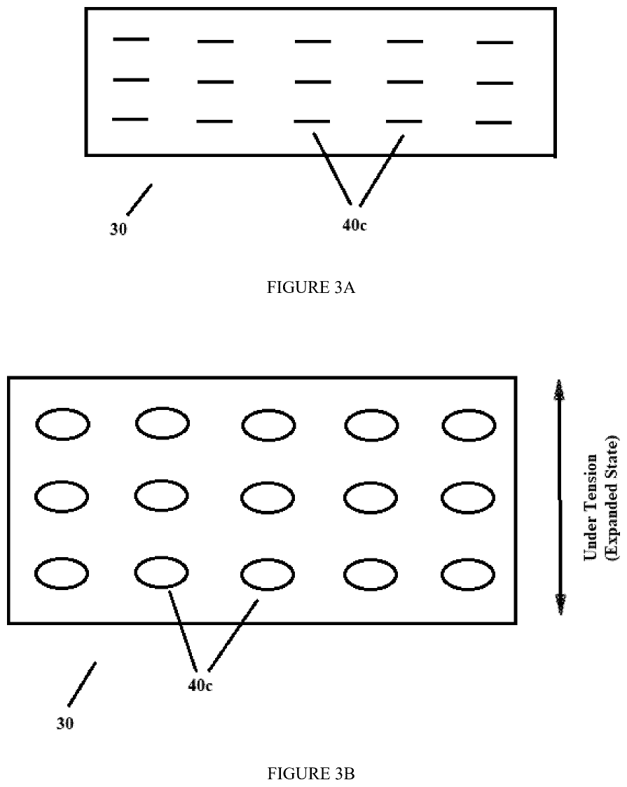

FIG. 3A illustrates a film 30 having a plurality of apertures 40c comprising individual slits in a relaxed (e.g., the film is under no tension) or closed state in accordance with certain embodiments of the invention. FIG. 3B illustrates the film 30 of FIG. 3A in an extended state (e.g., under tension) and the individual slits are in on open state in accordance with certain embodiments of the invention.

In accordance with certain embodiments of the invention, the film may have a thickness from about 1 to about 500 microns, such as at least about any of the following: 1, 3, 5, 8, 10, 15, 20, 25, 30, 35, 40, 45, 50, 55, 60, 70, 80, 90, 100, 120, 150, 180, 200, 220, and 250 microns, and/or at most about any of the following: 500, 480, 450, 420, 400, 380, 350, 320, 300, 280, and 250 microns. Additionally or alternatively, the film may have a basis weight from about 8 to about 100 gsm, such as at least about any of the following: 8, 10, 12, 15, 18, 20, 22, 25, 30, 35, 40, 45, and 50 gsm, and/or at most about any of the following: 100, 90, 80, 70, 60, and 50 gsm.

In accordance with certain embodiments of the invention, the film may be a single layer or a multi-layer film. For instance, the film may include from 1 to about 10 individual layer, such as at least about any of the following: 1, 2, 3, 4, and 5 individual layer, and/or at most about any of the following: 10, 9, 8, 7, 6, and 5 individual layers.

The film, in accordance with certain embodiments of the invention, may comprise a polymeric composition including (i) a polymer component and (ii) optionally an additive component, wherein the polymer component comprises one or more elastomers, such as those noted above. The polymeric composition may be monolithic, in which the polymeric material forms a monolithic film layer (e.g., portion of the film excluding the apertures) that allows the passage of water vapor therethrough. Alternatively, the film may be a microporous film (e.g., portion of the film excluding the apertures). In accordance with certain embodiments of the invention, the polymer component may further comprise one or more non-elastomeric polymers and/or a compatibilizer (e.g., a polymer different than the one or more elastomer and the one or more non-elastomeric polymers).

In accordance with certain embodiments of the invention, the one or more elastomers may account for about 30 to 100% by weight of the polymer component, such as at least about any of the following: 30, 35, 40, 45, 50, and 55% by weight of the polymer component, and/or at most about any of the following: 100, 98, 95, 92, 90, 85, 80, 75, 70, 65, 60, and 55% by weight of the polymer component. Additionally or alternatively, the one or more non-elastomeric polymers accounts for about 0 to 70% by weight of the polymer component, such as at least about any of the following: 0, 2, 5, 8, 10, 15, 20, 25, 30, 35, 40, and, 45% by weight of the polymer component, and/or at most about any of the following: 70, 65, 60, 55, 50, and 45% by weight of the polymer component.

In accordance with certain embodiments of the invention, the first nonwoven material may comprise a first plurality of continuous spunbond fibers, a first plurality of meltblown fibers, a first plurality of thermoplastic staple fibers, a first plurality of cellulosic fibers, or any combinations thereof. Additionally or alternatively, the second nonwoven material comprises a second plurality of continuous spunbond fibers, a second plurality of meltblown fibers, a second plurality of thermoplastic staple fibers, a second plurality of cellulosic fibers, or any combinations thereof. By way of example only, the first nonwoven material and/or the second nonwoven material may comprise a SM S construct including at least a first spunbond layer, at least one meltblown layer, and at least a second spunbond layer, in which the at least one meltblown layer is located between the first spunbond layer and the second spunbond layer. By way of yet another example, the first nonwoven material and/or the second nonwoven material may comprise a carded nonwoven fabric.

In accordance with certain embodiments of the invention, the first nonwoven material may comprise a basis weight from about 10 to about 200 gsm, such as at least about any of the following: 10, 15, 20, 30, 40, 50, 60, 80, and 100 gsm, and/or at most about any of the following: 200, 180, 160, 140, 120, and 100 gsm. Additionally or alternatively, the second nonwoven material comprises a basis weight from about 10 to about 200 gsm, such as at least about any of the following: 10, 15, 20, 30, 40, 50, 60, 80, and 100 gsm, and/or at most about any of the following: 200, 180, 160, 140, 120, and 100 gsm. Additionally or alternatively, the film may comprise from about 5 to about 50% by weight of the composite, such as at least about any of the following: 5, 6, 8, 10, 12, 15, 18, 20, 22, and 25% by weight of the composite, and/or at most about any of the following: 50, 45, 40, 35, 30, and 25% by weight of the composite. Additionally or alternatively, the composite may have a basis weight from about 10 to about 500 gsm, such as at least about any of the following: 10, 15, 20, 40, 50, 60, 80, 100, 120, 150, 180, 200, 220, and 250 gsm, and/or at most about any of the following: 500, 450, 400, 350, 300, 280, and 250 gsm.

In accordance with certain embodiments of the invention, the composite and/or the film may have a permanent set of less than 25%, such as less than about any of the following: 25, 20, 18, 15, 12, 10, 8, 6, 5, 4, 2, and 1%.

The composite, in accordance with certain embodiments of the invention, includes a first outermost surface and a second outermost surface, in which one or both may include a three-dimensional pattern imparted therein. In this regard, the plurality of fibers associated with the respective outermost surface may be physically maneuvered, such as by hydroentanglement, to mold the respective outermost surface(s) to be molded to a pattern of an image transfer surface (e.g., image transfer sleeve). In accordance with certain embodiments of the invention, the first outermost surface and the second outermost surface have the same three-dimensional pattern. Alternatively, the first outermost surface may have a first three-dimensional pattern and the second outermost surface has a second three-dimensional pattern, wherein the first three-dimensional pattern is different than the second three-dimensional pattern.

In accordance with certain embodiments of the invention, the three-dimensional pattern(s) may comprise a plurality of raised sections and a plurality of recessed portions relative to an x-y plane located at the midpoint in a z-direction of the respective nonwoven material in which the raised sections are located above the midpoint and the recessed portions are located below the midpoint. Although the particular three-dimensional pattern(s) are not particularly limited, the plurality of raised sections and the plurality of recessed portions are located as alternating rows. For example, the alternating rows are linear, arcuate, or have a zig-zag geometry.

In accordance with certain embodiments of the invention, an average height of the plurality of raised sections relative to the midpoint, as noted above, may be from about 0.5 to about 10 mm, such as at least about any of the following: 0.5, 0.8, 1, 1.5, 2, 2.5, 3, 3.5, 4, 4.5, and 5 mm, and/or at most about any of the following: 10, 9, 8, 7, 6, and 5 mm. Additionally or alternatively, an average depth of the plurality of recessed sections relative to the midpoint, as noted above, may be from about 0.5 to about 10 mm, such as at least about any of the following: 0.5, 0.8, 1, 1.5, 2, 2.5, 3, 3.5, 4, 4.5, and 5 mm, and/or at most about any of the following: 10, 9, 8, 7, 6, and 5 mm.

In another aspect, certain embodiments according to the invention provide a method of forming a composite (e.g., breathable elastic composite) including the following steps: (i) providing or forming a first nonwoven material comprising a first plurality of fibers; (ii) providing or forming a second nonwoven material comprising a second plurality of fibers; (iii) providing or forming a film comprising a plurality of apertures; (iv) positioning the film between the first nonwoven material and the second nonwoven material; and (v) physically entangling at least a portion the first plurality of fibers and/or at least a portion of the second plurality of fibers together through at least a portion of the plurality of apertures.

In accordance with certain embodiments of the invention, the step of physically entangling at least a portion the first plurality of fibers and/or at least a portion of the second plurality of fibers together through at least a portion of the plurality of apertures comprises subjecting the intermediate material to an air-entanglement operation and/or a hydroentanglement operation. For instance, the air-entanglement operation and/or the hydroentanglement operation comprises impacting a first outermost surface of the intermediate material to water jets at a pressure from about 800 psi to about 4000 psi, such as at least about any of the following: 800, 1000, 1200, 1400, 1500, 1600, 1800, and 2000 psi, and/or at most about any of the following: 4000, 3800, 3500, 3200, 3000, 2800, 2500, 2200, and 2000 psi. Additionally or alternatively, the air-entanglement operation and/or the hydroentanglement operation comprises impacting a second outermost surface of the intermediate material to water jets at a pressure from about 800 psi to about 4000 psi, such as at least about any of the following: 800, 1000, 1200, 1400, 1500, 1600, 1800, and 2000 psi, and/or at most about any of the following: 4000, 3800, 3500, 3200, 3000, 2800, 2500, 2200, and 2000 psi.

In accordance with certain embodiments of the invention, physically entangling at least a portion the first plurality of fibers and/or at least a portion of the second plurality of fibers together through at least a portion of the plurality of apertures comprises imparting a three-dimensional pattern to the first outmost surface, the second outermost surface, or both (e.g., such as those described above).

In accordance with certain embodiments of the invention, the step of imparting the three-dimensional pattern comprises positioning the intermediate nonwoven material adjacent a three-dimensional imaging device (e.g., roll) having the desired three-dimensional pattern and subjecting the intermediate nonwoven material to at least one fluid stream. In accordance with certain embodiments of the invention, the physically entangling at least a portion the first plurality of fibers and/or at least a portion of the second plurality of fibers together through at least a portion of the plurality of apertures may be conducted prior to the imaging operation or at the same time.

Suitable three-dimensional imaging devices (e.g., rolls) may comprise imaging sleeves include those described, for example, in RE38,105 and RE38,505, in which the contents of both are hereby incorporated by reference in their entirety. For example, the composite may include a three-dimensional pattern formed therein, such as by maneuvering the fibers of the respective outermost surface to conform to the pattern on the imaging sleeve. For example, the image transfer device may comprise one or more drums or even one or more sleeves affixed to a corresponding drum. One or more water jets, for example, may be applied to a side of the composite opposite to the side contacting the image transfer device. Without intending to be bound by the theory, the one or more water jets of fluid (e.g., water) directed through the nonwoven outer layer causes the fibers of that layer to become displaced according to the image on the image transfer device such as the image formed on one or more drums or one or more sleeves affixed to a corresponding drum causing a three-dimensional pattern to be imaged throughout the nonwoven according to such image. Such imaging techniques are further described in, for example, U.S. Pat. No. 6,314,627 entitled “Hydroentangled Fabric having Structured Surfaces”; U.S. Pat. No. 6,735,833 entitled “Nonwoven Fabrics having a Durable Three-Dimensional Image”; U.S. Pat. No. 6,903,034 entitled “Hydroentanglement of Continuous Polymer Filaments”; U.S. Pat. No. 7,091,140 entitled “Hydroentanglement of Continuous Polymer Filaments”; and U.S. Pat. No. 7,406,755 entitled “Hydroentanglement of Continuous Polymer Filaments” each of which are hereby incorporated by reference in their entirety herein by reference. As noted above, the at least one fluid stream may be liquid water.

### Examples

The present disclosure is further illustrated by then following examples, which in no way should be construed as being limiting. That is, the specific features described in the following examples are merely illustrative and not limiting.

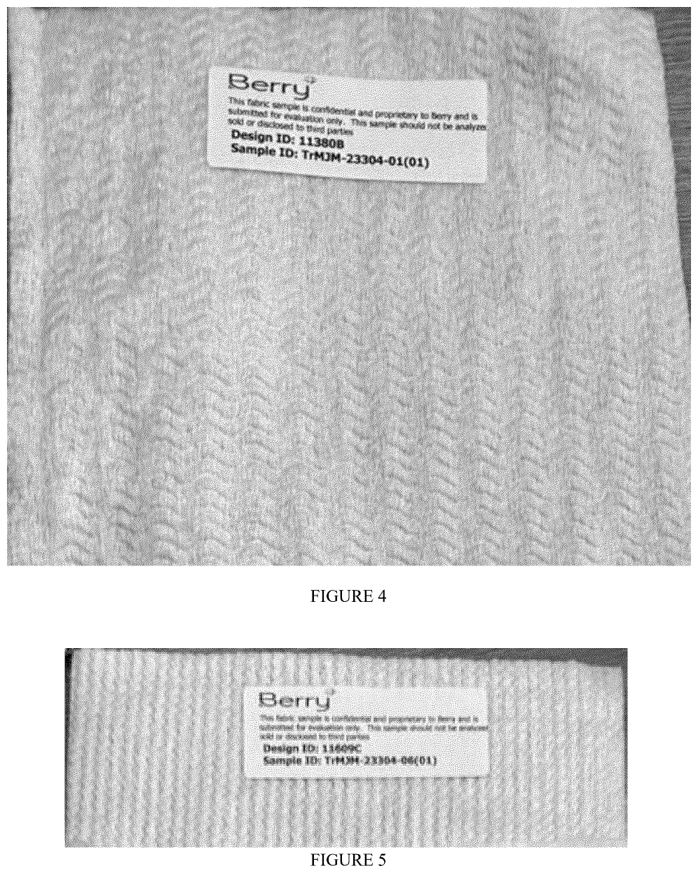

An intermediate material having a nonwoven-film-nonwoven structure was fixed on an image-transfer device (ITD) surface, which was itself mounted on a rotating drum that spins the ITD surface and intermediate material past a manifold having a plurality of water jets discharging water onto the intermediate material to hydroentangle the nonwoven materials together through apertures of the film. The intermediate material was passed by the manifold three times to simulate three different sequentially positioned manifolds at the ITD on an in-line process. The samples used were a 30 gsm 100% PET nonwoven for both nonwoven materials located on opposite sides of the film. As such, all samples has a PET/Film/PET structure. The samples were made with two different ITD patterns: Design 11380B (a CD-oriented wave) as shown on FIG. 4 and Design 11609C (an M D-oriented ‘zigzag’) as shown on FIG. 5. The samples were produced at hydroentangling pressures ranging from 1500 psi to 3000 psi and a speed of 50 fpm. The former yielded subjectively better bonding. For both designs, the higher pressures achieved effective nonwoven to nonwoven bonding through the apertured film and the hydroentangled elastic laminate exhibits good elasticity with the pattern image remaining intact. Table 1 summarizes certain properties of the samples.

TABLE 1

| Design | | | Hydroentangling Conditions | | TM-7726 | | | | | | | |
|---|---|---|---|---|---|---|---|---|---|---|---|---|
| ID | Qty | Sample Composition | Pressure (psi) | Speed (fpm) | Delamination Peel Strength Test (lbf-in) | | | | | | avg | stdev |
| 11380B | 3 | 30 gsm PET/Apertured Film/30 gsm PET | 1500 | 50 | 0.25 | 0.26 | 0.23 | 0.27 | 0.29 | 0.27 | 0.26 | 0.020 |
| 11380B | 3 | 30 gsm PET/Apertured Film/30 gsm PET | 2000 | 50 | 0.45 | 0.4 | 0.72 | 0.53 | 0.4 | 0.49 | 0.50 | 0.120 |
| 11380B | 3 | 30 gsm PET/Apertured Film/30 gsm PET | 2500 | 50 | 1.31 | 1.42 | 1.05 | 1.56 | 0.99 | 1.44 | 1.30 | 0.228 |
| 11380B | 3 | 30 gsm PET/Apertured Film/30 gsm PET | 3000 | 50 | 2.52 | 2.42 | 5.44 | 4.94 | 5.17 | 4.59 | 4.18 | 1.354 |
| 11609C | 3 | 30 gsm PET/Apertured Film/30 gsm PET | 1500 | 50 | 0.59 | 0.43 | 0.39 | 0.42 | 0.34 | 0.39 | 0.43 | 0.086 |
| 11609C | 3 | 30 gsm PET/Apertured Film/30 gsm PET | 2000 | 50 | 1.42 | 1.86 | 0.85 | 1.49 | 2.44 | 0.59 | 1.44 | 0.671 |
| 11609C | 3 | 30 gsm PET/Apertured Film/30 gsm PET | 2500 | 50 | 4.41 | 2.84 | 2.91 | 2.36 | 4.36 | 2.99 | 3.31 | 0.860 |
| 11609C | 3 | 30 gsm PET/Apertured Film/30 gsm PET | 3000 | 50 | 6.52 | 9.16 | 8.3 | 7.22 | 4.53 | 7.96 | 7.28 | 1.624 |

These and other modifications and variations to the invention may be practiced by those of ordinary skill in the art without departing from the spirit and scope of the invention, which is more particularly set forth in the appended claims. In addition, it should be understood that aspects of the various embodiments may be interchanged in whole or in part. Furthermore, those of ordinary skill in the art will appreciate that the foregoing description is by way of example only, and it is not intended to limit the invention as further described in such appended claims. Therefore, the spirit and scope of the appended claims should not be limited to the exemplary description of the versions contained herein.

What is claimed is:

1. A composite, comprising;
(i) a first nonwoven material comprising a first plurality of fibers;
(ii) a second nonwoven material comprising a second plurality of fibers; and
(iii) a film comprising a plurality of apertures, wherein the film is located between the first nonwoven material and the second nonwoven material;
wherein at least a portion the first plurality of fibers and/or at least a portion of the second plurality of fibers extend through at least a portion of the plurality of apertures and are physically entangled together.

2. The composite of claim 1, wherein the plurality of apertures define an open area from about 0.1 to about 90% in a relaxed state.

3. The composite of claim 1, wherein the film has an aperture density from about 1 aperture per cm² to about 300 apertures per cm².

4. The composite of claim 1, wherein the plurality of apertures comprises a plurality of slits that are in a closed state when the film is in a relaxed state and transition to an open state when the film is under tension or in an extended state and/or a plurality of freely open apertures having an average area from about 0.02 to about 200 mm² when the film is in a relaxed state.

5. The composite of claim 4, wherein the plurality of slits each have a short dimension and a long direction, and wherein the respective long dimensions are aligned in a cross-direction (CD) of the film or wherein the respective long dimensions are aligned in a machine-direction (BD) of the film.

6. The composite of claim 4, wherein the plurality of slits each have a short dimension and a long direction, and wherein the respective long dimensions are aligned at an angle from about 5 to about 85° from a cross-direction (CD) of the film.

7. The composite of claim 4, wherein the plurality of apertures comprise a truncated structure having an out-of-plane geometry in relation to a plane defined by the film.

8. The composite of claim 4, wherein the plurality of aperture comprise a planar structure substantially devoid of an out-of-plane geometry in relation to a plane defined by the film.

9. The composite of claim 1, wherein the film has a thickness from about 1 to about 500 microns.

10. The composite of claim 1, wherein the film has a basis weight from about 8 to about 100 gsm.

11. The composite of claim 1, wherein the film includes from 1 to about 10 individual layer.

12. The composite of claim 1, wherein the film comprises a polymeric composition including an polymer component and optionally an additive component, wherein the polymer component comprises one or more elastomers.

13. The composite of claim 12, wherein the film comprises a vapor permeable film comprising a monolithic film or a microporous film.

14. The composite of claim 1, wherein the first nonwoven material comprises a first plurality of continuous spunbond fibers, a first plurality of meltblown fibers, a first plurality of thermoplastic staple fibers, a first plurality of cellulosic fibers, or any combinations thereof, and the second nonwoven material comprises a second plurality of continuous spunbond fibers, a second plurality of meltblown fibers, a second plurality of thermoplastic staple fibers, a second plurality of cellulosic fibers, or any combinations thereof.

15. The composite of claim 1, wherein the first nonwoven material and/or the second nonwoven material comprises a basis weight from about 10 to about 200 gsm.

16. The composite of claim 1, wherein the film comprises from about 5 to about 50% by weight of the composite.

17. The composite of claim 1, wherein the composite has a permanent set of less than 25%.

18. A method of forming a composite, comprising:
(i) providing or forming a first nonwoven material comprising a first plurality of fibers;
(ii) providing or forming a second nonwoven material comprising a second plurality of fibers;
(iii) providing or forming a film comprising a plurality of apertures;
(iv) positioning the film between the first nonwoven material and the second nonwoven material to provide an intermediate material; and
(v) physically entangling at least a portion the first plurality of fibers and/or at least a portion of the second plurality of fibers together through at least a portion of the plurality of apertures.

19. The method of claim 18, wherein physically entangling at least a portion the first plurality of fibers and/or at least a portion of the second plurality of fibers together through at least a portion of the plurality of apertures comprises subjecting the intermediate material to an air-entanglement operation and/or a hydroentanglement operation.

20. The method of claim 19, wherein the hydroentanglement operation comprises impacting a first outermost surface and/or the second outermost surface of the intermediate material to water jets at a pressure from about 800 psi to about 4000 psi.
